(19) United States
(12) Patent Application Publication
(10) Pub. No.: US 2003/0206193 A1
(43) Pub. Date: Nov. 6, 2003

(54) Communication control system and storage medium for storing image transfer program

(76) Inventors: Keizo Sato, Fukuoka (JP); Masako Yoshimura, Fukuoka (JP); Tomofumi Nakayama, Fukuoka (JP); Junzo Ikuta, Fukuoka (JP); Yasuyuki Numata, Fukuoka (JP)

Correspondence Address: RATNERPRESTIA, P O BOX 980, VALLEY FORGE, PA, 19482-0980, US

(21) Appl. No.: 10/409,326

(22) Filed: Apr. 8, 2003

(30) Foreign Application Priority Data
Apr. 17, 2002 (JP) 2002-114546

(51) Int. Cl. G09G 5/00

(52) U.S. Cl. 345/736

(57) ABSTRACT

The present invention provides a communication control system that includes a control terminal having a display unit for displaying an image and a controlled computer, and transmits image information stored in the computer to the terminal. The terminal transmits image display capability information of the terminal, and the computer then receives it. The computer processes the image information of the computer based on the image display capability information of the terminal, and transmits it to the terminal. The terminal receives the changed image information and displays it on the display unit. This process allows efficient communication. When such control is stored as a program in a storage medium, a general computer can be controlled.

### BACKGROUND OF THE INVENTION

1. Field of the Invention

The present invention relates to a communication control system for accurately displaying an image fed from a network or the like on the display screen of the other device, and a storage medium for storing a program for controlling such image transfer.

2. Background Art

Some remote control method of a computer includes a step of transmitting displayed contents of a controlled computer to a control computer, or transmitting input information from the control computer to the controlled computer. In such a method, display capability (for example, resolution) of the display of the control computer must be equivalent to that of the controlled computer.

Recently, computers have remarkably become widespread, and types of the computers are various; for example, a desktop personal computer (PC), and a so-called mobile terminal such as a note PC, a personal digital assistance (PDA), and a portable phone. The mobile terminal is generally downsized focusing attention on the portability, so that hardware performance such as display capability, central processing unit (CPU) performance, or memory capacity of the mobile terminal is lower than that of the desktop PC. Even when the entire screen information of the desktop PC is transmitted to the mobile terminal for remote control of the desktop PC from the mobile terminal, the mobile terminal can display only a part of the transmitted image. A typical image has much data and takes much time to transfer the image. Transmitting data in a region that is not displayed on the mobile terminal increases communication traffic, produces a display waiting state until receiving of the image is finished, and causes delay of the display to make the user of the mobile terminal uncomfortable. The uncomfortableness can be eliminated when the mobile terminal accepts an operation command from the user while sequentially displaying the received image data. In this case, however, display processing and user command processing must be simultaneously executed. When the mobile terminal has low hardware performance, the response becomes slow.

For reducing the communication traffic, a method is performed in which only an update part of the screen is transmitted to the mobile terminal after the display screen image of the desktop PC is displayed on the mobile terminal. When a window having a size close to that of the screen is moved in the PC using Windows (registered trademark of Microsoft Co., Ltd.) in this method, for example, image information corresponding to the screen having the same size as that in the desktop PC is transferred. When an object changed periodically in display exists in a region that is not displayed on the terminal, display image information is transmitted and received though the state of the screen of the mobile terminal does not change at all. For example, the object includes animation graphics interchange format (Gif) displayed on a browser. In this case, the communication traffic increases.

A method is also performed in which the communication traffic is reduced by compressing and transmitting the display image information. In this method, the mobile terminal requires specific hardware or software for depressing the compressed image at a mobile terminal In other words, the hardware performance such as high-performance CPU or large capacity memory for depressing the compressed image must be improved to result in cost increase of the terminal.

### SUMMARY OF THE INVENTION

The present invention provides a communication control system that includes a terminal having a display unit for displaying an image and a computer, and transmits image information stored in the computer to the terminal. The terminal transmits image display capability information to the computer. The computer changes the image information based on the image display capability information and transmits the image information to the terminal. The terminal receives the changed image information and displays it on the display unit. The present invention also provides a storage medium for storing a program for controlling the terminal and the computer as discussed above.

### BRIEF DESCRIPTION OF THE DRAWINGS

FIG. 1 is a function block diagram of a communication control system in accordance with an exemplary embodiment of the present invention.

FIG. 2 is a circuit block diagram of the communication control system in accordance with the exemplary embodiment.

FIG. 3 is a flow chart showing an operation of a control terminal in accordance with the exemplary embodiment.

FIG. 4 is a flow chart showing an operation of an image transfer server in accordance with the exemplary embodiment.

FIG. 5 shows a screen image of a controlled computer and a screen image to be displayed on the control terminal in accordance with the exemplary embodiment.

FIG. 6 shows the control terminal in accordance with the exemplary embodiment.

FIG. 7 shows a screen of the controlled computer in accordance with the exemplary embodiment.

FIG. 8 shows the screen image of the controlled computer and another screen image to be displayed on the control terminal in accordance with the exemplary embodiment.

FIG. 9 shows the control terminal in accordance with the exemplary embodiment.

FIG. 10 shows a region of an image transmitted from the controlled computer to the control terminal in accordance with the exemplary embodiment.

FIG. 11 is a flow chart showing another operation of the image transfer server in accordance with the exemplary embodiment.

FIG. 12 shows a region of an image transmitted from the controlled computer to the control terminal in accordance with the exemplary embodiment.

FIG. 13A and FIG. 13B show screen images displayed on the controlled computer and the control terminal in accordance with the exemplary embodiment.

FIG. 14 is a flow chart showing still another operation of the image transfer server in accordance with the exemplary embodiment.

FIG. 15 shows the control terminal in accordance with the exemplary embodiment.

FIG. 16, FIG. 17, and FIG. 18 show regions of an image transmitted from the controlled computer to the control terminal in accordance with the exemplary embodiment.

### DETAILED DESCRIPTION OF THE INVENTION

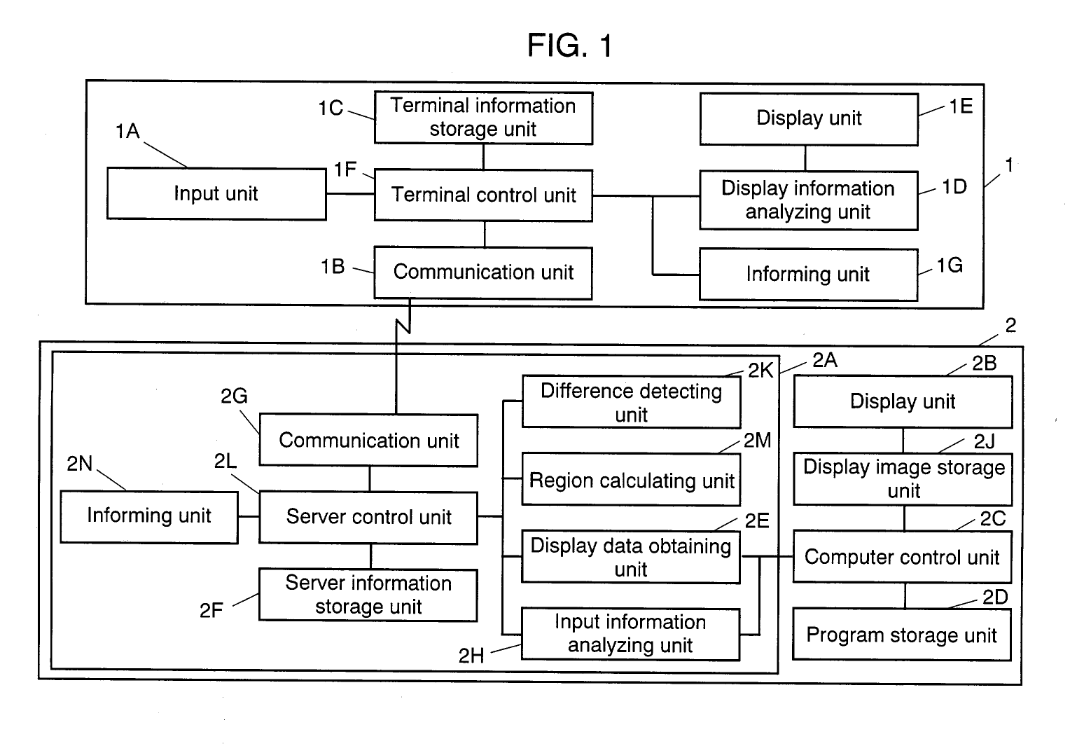

FIG. 1 is a function block diagram of a communication control system in accordance with an exemplary embodiment of the present invention. The remote communication control system of the present exemplary embodiment has communication control terminal (it is hereinafter called terminal) 1 and controlled computer (hereinafter, PC) 2. Terminal 1 is connected to PC 2 via a communication line.

Terminal 1 includes input unit 1A used for user input, terminal control unit (hereinafter, control unit) 1F, and communication unit 1B. Communication unit 1B transmits image display capability information of terminal 1 and input information fed from input unit 1A to PC 2 via control unit 1F and receives display image information from PC 2. Terminal 1 further includes terminal information storage unit (hereinafter, storage unit) 1C, display information analyzing unit (hereinafter, analyzing unit) 1D, and display unit 1E. Storage unit 1C stores the display image information of PC 2 received from communication unit 1B and display capability information of terminal 1. Analyzing unit 1D analyzes the display image information stored in storage unit 1C. Display unit 1E displays the display image information analyzed by analyzing unit 1D. Control unit 1F controls an operation of terminal 1.

PC 2 includes image transfer server (hereinafter, server) 2A, display unit 2B, display image storage unit (hereinafter, storage unit) 2J, computer control unit (hereinafter, control unit) 2C, and program storage unit (hereinafter, storage unit) 2D. Storage unit 2J temporarily stores image information to be displayed on display unit 2B. Storage unit 2D stores an operating system (OS) program operated in control unit 2C and PC 2, and an application program operated on the OS program of PC 2.

Server 2A has display data obtaining unit (hereinafter, obtaining unit) 2E, server information storage unit (hereinafter, storage unit) 2F, communication unit 2G, input information analyzing unit (hereinafter, analyzing unit) 2H, server control unit (hereinafter, control unit) 2L, informing unit 2N, difference detecting unit (hereinafter, detecting unit) 2K, and region calculating unit 2M. Obtaining unit 2E obtains the display image information displayed on PC 2 from display unit 2B or storage unit 2J of PC 2. Obtaining unit 2E also processes (changes) the image information based on the display capability information, so that obtaining unit 2E works also as a changing unit. Storage unit 2F stores the display image information obtained and processed by obtaining unit 2E. Communication unit 2G receives the display capability information and the input information from terminal 1, and transmits the display image information stored in storage unit 2F to terminal 1. Analyzing unit 2H analyses the input information such as commands received from communication unit 2G, and transmits it as instruction request to control unit 2C. Control unit 2L controls an operation of server 2A. Informing unit 2N gives the alarm to a user with a display or a sound. Detecting unit 2K detects a difference between the image information transmitted to terminal 1 and an image displayed in response to the instruction from terminal 1. Region calculating unit 2M calculates area of a region having a predetermined frame shape displayed on the screen of display unit 1E of terminal 1. The predetermined frame corresponds to a window in Windows (registered trademark of Microsoft Co., Ltd.), for example, and the user can send an operation command to the window from terminal 1.

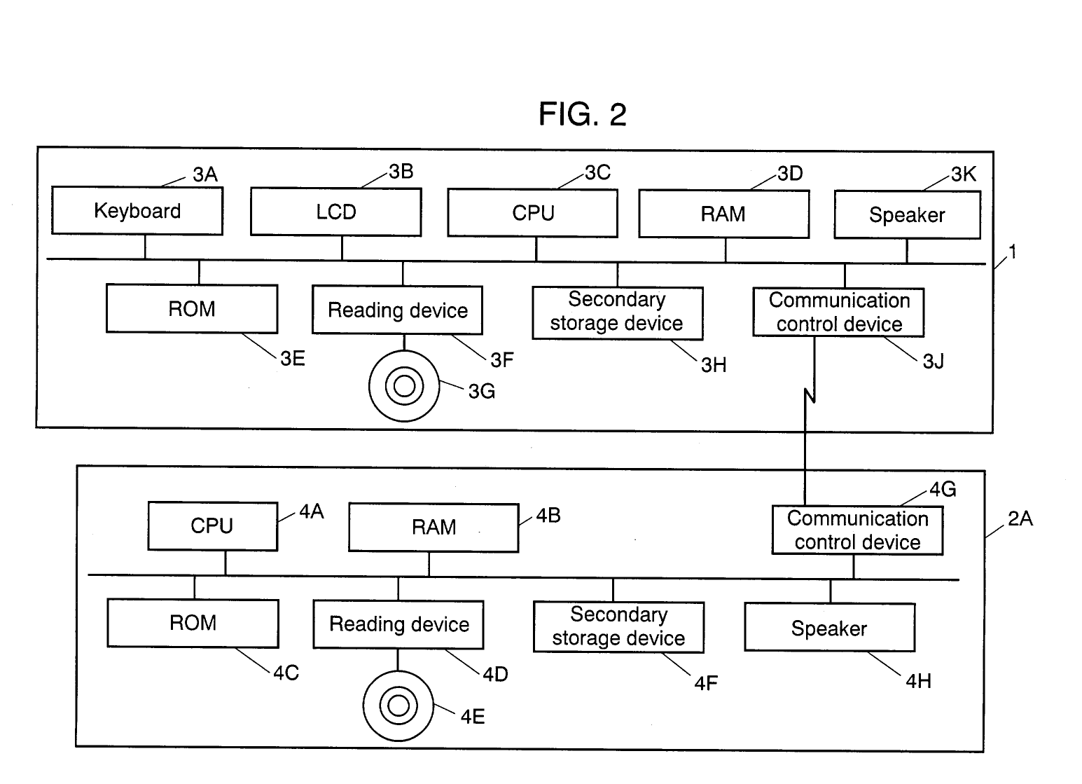

FIG. 2 is a circuit block diagram of the communication control system in accordance with the exemplary embodiment.

In FIG. 2, terminal 1 has keyboard 3A, liquid crystal display (LCD) 3B, central processing unit (CPU) 3C, random access memory (RAM) 3D, read only memory (ROM) 3E, reading device 3F, secondary storage device 3H, communication control device (hereinafter, control device) 3J, and speaker 3K. Reading device 3F reads storage medium 3G such as a compact disk (CD)-ROM, and a digital versatile disc (DVD)-ROM. Control unit 3J connects to an external line through a telephone line or a network cable and the like.

Server 2A has CPU 4A, RAM 4B, ROM 4C, reading device 4D, secondary storage device 4F, communication control device (hereinafter, control device) 4G, and speaker 4H. Reading device 4D reads storage medium 4E such as a CD-ROM. Control device 4G connects to an external line through a telephone line or a network cable and the like.

A relation between the function block diagram of FIG. 1 and the circuit block diagram FIG. 2 is hereinafter described. In FIG. 1 and FIG. 2, storage unit 1C is formed of RAM 3D in terminal 1. Input unit 1A is formed of keyboard 3A, but may include a mouse or a touch panel. Display unit 1E, communication unit 1B, and informing unit 1G are formed of LCD 3B, communication control device 3J, and speaker 3K, respectively. Informing unit 1G displays a caution also on the screen of LCD 3B. Control unit IF and analyzing unit ID are formed of hardware where CPU 3C executes a program stored in ROM 3E while exchanging data with RAM 3D, ROM 3E, and secondary storage device 3H.

In server 2A, storage unit 2F is formed of RAM 4B. An OS program and an application program are stored in one of RAM 4B, ROM 4C, and secondary storage device 4F. Communication unit 2G includes control device 4G. Control unit 2L, obtaining unit 2E, and analyzing unit 2H are formed of hardware where CPU 4A executes a program stored in ROM 4C while exchanging data with RAM 4B, ROM 4C, and secondary storage device 4F. Difference detecting unit 2K and region calculating unit 2M are similarly formed of hardware where CPU 4A executes the program. Display image storage unit 2J in PC 2 is formed of RAM 3D.

In terminal 1 of the present embodiment, CPU 3C executes the program stored in ROM 3E, but may execute a program stored in storage medium 3G using reading device 3F. In server 2A, CPU 4A executes the program stored in ROM 4C, but may execute a program stored in storage medium 4E using reading device 4D. CPU 4A may work as control unit 2C in PC 2. Two or more of storage units 2F, 2J, and 2D may be formed of the same device.

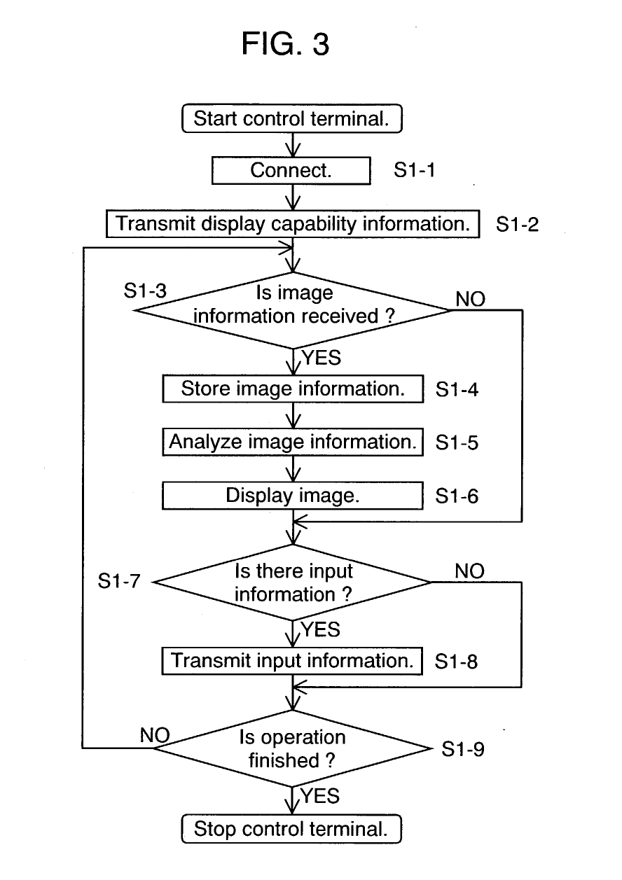

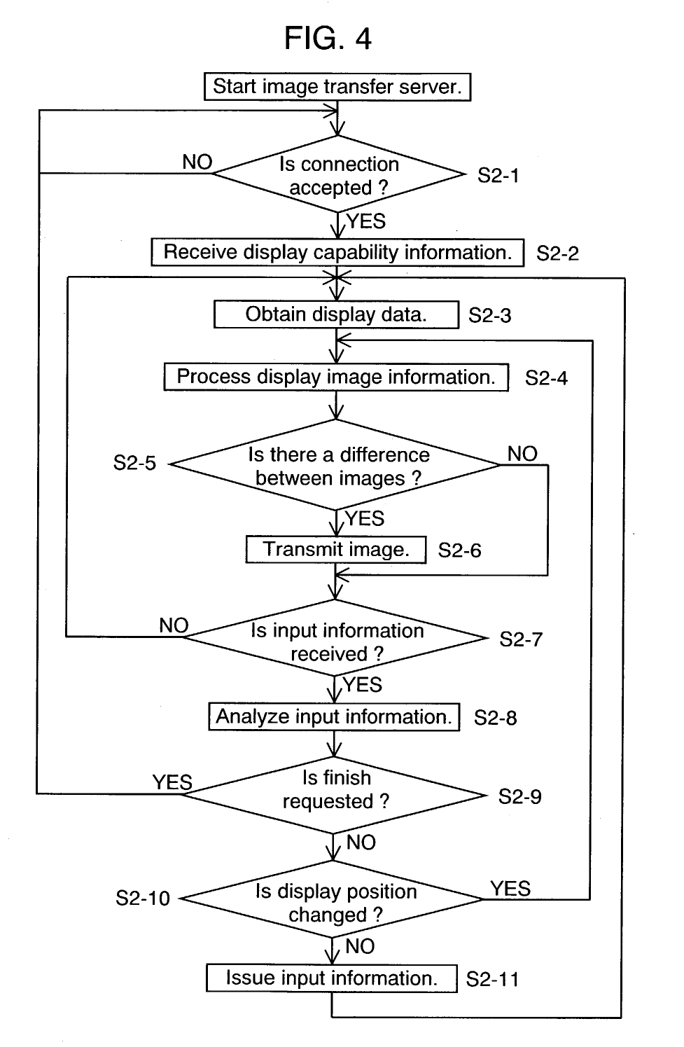

An information displaying method in terminal 1 having such a configuration is described with reference to flowcharts of FIG. 3 and FIG. 4. The flowchart of FIG. 3 shows a process where CPU 3C executes the program stored in ROM 3E. The flowchart of FIG. 4 shows a process where CPU 4A executes the program stored in ROM 4C. In the flowchart of FIG. 3, terminal 1 is started, and server 2A receives image information on the display screen of PC 2 and displays it on LCD 3B. In the flowchart of FIG. 4, server 2A receives a connection request from terminal 1, obtains and processes the display image information of PC 2, and transmits it to terminal 1.

Firstly, a user starts terminal 1 to start the process. After the starting, the user specifies a server to be connected to input unit 1A. When Transmission Control Protocol/Internet Protocol (TCP/IP) is employed as a communication protocol, for example, the user specifies IP address. Terminal 1 then transmits a connection request to image transfer server 2A (S1-1).

A user starts terminal 1 and then connects it to server 2A with a request by the user in the present embodiment; however, the present invention is not limited to this connecting method but a connecting method of connecting terminal 1 to a predetermined server 2A simultaneously with the starting may be employed.

In server 2A, server control unit 2L receives the connection request from terminal 1 via communication unit 2G and establishes the connection (S2-1).

In terminal 1, next, terminal control unit 1F obtains image display capability information stored in terminal information storage unit 1C and transmits it to communication unit 2G on the PC 2 side via communication unit 1B (S1-2).

Display capability information of display unit 2B of PC 2 in the present embodiment includes a screen size, a resolution of super video graphics array (SVGA) (1280×1024), and “full color display”. Display capability information of terminal 1 includes a screen size, a resolution of quarter VGA (QVGA) (320×240), and pixel information of 8 bit/pixel. All display capability information of terminal 1 need not be transmitted to PC 2 in the present invention. Display capability information is not limited to a screen size, a resolution, and pixel information, but may include color pallet information and gradation information.

In the present embodiment, in transmitting the display capability information from terminal 1, the resolution and the pixel information (bit/pixel) of display unit 1E are transmitted. Based on the display capability information, server 2A transmits display image information having terminal pixel information converted from pixel information of each image. When the pixel information of terminal 1 differs from that of PC 2, the image conversion is not required in terminal 1. Terminal 1 does not require a resource for the image conversion, and is therefore inexpensive.

In server 2A, next, control unit 2L receives the display capability information from terminal 1 through communication unit 2G and stores the information in storage unit 2F (S2-2).

Control unit 2L then starts obtaining unit 2E to operate the OS program. Control unit 2C, based on the OS program, obtains first display image information from storage unit 2F (RAM 4B) and transmits the image information to obtaining unit 2E. Obtaining unit 2E stores the first display image information in storage unit 2F (S2-3).

In the present embodiment, obtaining unit 2E issues a request to control unit 2C, and control unit 2C then obtains the first display image information from RAM 4B. However, the present invention is not limited to this embodiment. Obtaining unit 2E may directly extract the first display image information from RAM 4B, for example.

Obtaining unit 2E then obtains the display capability information of terminal 1 stored in storage unit 2F in step S2-2, extracts display image information having the obtained resolution from the first display image information stored in storage unit 2F, and produces second display image information.

The display capability information of terminal 1 includes the resolution in the example discussed above; however, the display capability information may include the screen size instead of the resolution and the image may be extracted in response to the screen size.

The display capability information sent from terminal 1 may be previously stored in storage unit 2F, and, based on the display capability information, obtaining unit 2E may extract the image having the size of LCD 3B of terminal 1 from the display image information and converts the pixel. This method does not require the transmission of the display capability information from terminal 1 to server 2A, and therefore reduces transaction required for transmission and reception of the display capability information.

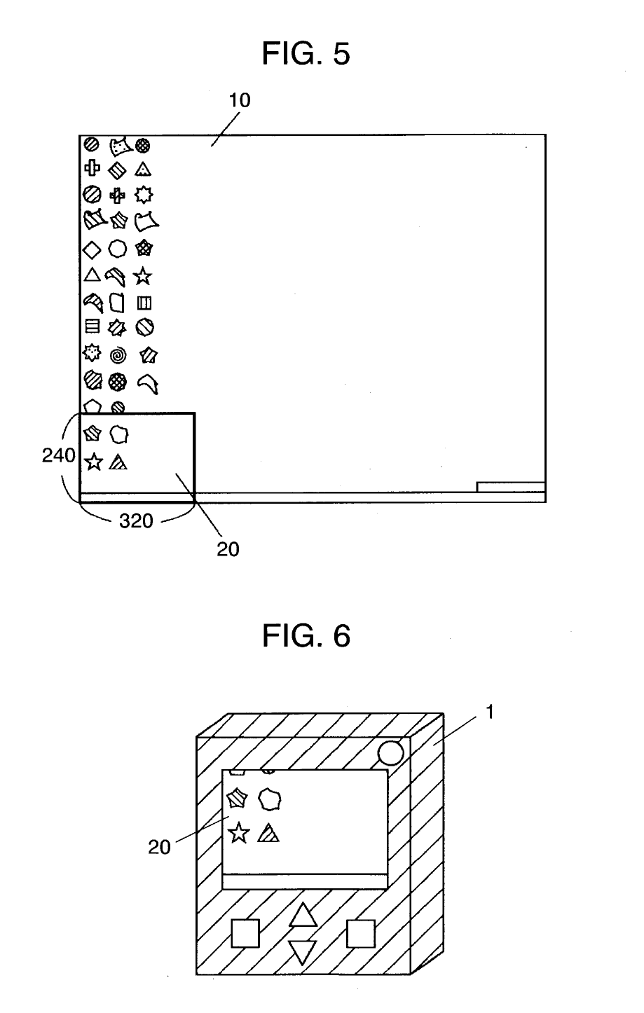

Display unit 1E of terminal 1 displays a lowest left part in display unit 2B of PC 2 just after the starting in the present embodiment. Obtaining unit 2E sets origin coordinates (0, 0) at the lowest left point, and extracts a rectangular region of the origin to (320, 240), QVGA size. Storage unit 2F stores second display image information produced after the extraction (S2-4). FIG. 5 shows displayed image 10 of the controlled computer and extracted image 20.

Extracted image 20 just after starting terminal 1 employs the lowest left point as the origin in the present embodiment; however, origin coordinates are not limited to this point but the user may specify the other origin coordinates, for example. A coordinate point in using terminal 1 may also be stored and the point may be employed as the origin coordinates.

Storage unit 2F stores the image of the screen and coordinate information ((0, 0), (320, 240)) after the extraction, namely the second display image information produced after the extraction. The present invention is not limited to the storing method of the display image information, but the coordinate information of the image that is transmitted to terminal 1 based on the first display image information may be stored. The coordinate information of the image is stored in storage unit 2F.

Next, difference detecting unit 2K compares the image of the second display image information that has been stored in storage unit 2F and has been last time transmitted to terminal 1, with the image of second display image information to be newly stored. Difference detecting unit 2K inspects whether or not there is a difference between the images (S2-5). At this time, the difference is extracted by comparing all corresponding pixels of the images. The process proceeds to step S2-6 when the difference exists, and proceeds to step S2-7 when no difference exists. When existing of the difference is determined, control unit 2L transmits the second display image information to terminal 1 through communication unit 2G (S2-6). Incidentally, step S2-6 is executed just after the starting, because no previous second display image information is stored.

In terminal 1, control unit IF receives, through communication unit 1B, the second display image information transmitted from server 2A (S1-3). Storage unit IC stores the received second display image information (S1-4).

Control unit IF then starts analyzing unit ID and analyzes the second display image information stored in storage unit 1C (S1-5). Display image information of the present embodiment is bitmap data. Analyzing unit ID obtains size information and information such as number of dots per pixel from the header of the bitmap data based on the structure of the bitmap data.

Analyzing unit ID displays the second display image information on display unit 1E in response to the analyzed information (S1-6), and waits for an operation from a user or image transmission from server 2A. FIG. 6 shows the state of terminal 1 at this time.

A case of receiving an operation command from the user is hereinafter described. In FIG. 3, control unit IF detects the operation command from the user (S1-7), and transmits input information to server 2A via communication unit 1B (S1-8).

The input information of the present embodiment has a data structure of (input event, coordinate information). A case where the user taps an icon twice on a touch panel is described. At this time, the input information of (“tap LCD twice”, tapped coordinates), for example, is transmitted.

In server 2A, control unit 2L receives input information such as a transmitted command via communication unit 2G (S2-7). Control unit 2L then sends the received input information to analyzing unit 2H, and analyzing unit 2H analyzes the input information (S2-8).

In analyzing the input information, analyzing unit 2H converts an event generated by operation of a button of terminal 1 or a touch panel on the LCD into an event formation in response to event corresponding information. The event corresponds information for corresponding event information of the mouse and keyboard used for operating the OS. Events of the control terminal are converted to OS operation events as below, for example.

| Events of control terminal | OS operation events |
|---|---|
| Tap the LCD once | Click on the mouse once |
| Tap the LCD twice | Click on the mouse twice |
| Drag the LCD | Drag the mouse |

Analyzing unit 2H issues the event after the conversion, as an event for an OS program, to control unit 2C (S2-10).

The event of the control terminal is assumed to be “Tap the LCD twice” in the present embodiment. Analyzing unit 2H then converts the event to the double click event of the mouse, and issues the double click event and coordinate information to control unit 2C. When the received input information is a request for completion, server 2A finishes the present communication process to wait for connection (S2-9). When server 2A issues the event to control unit 2C, PC 2 executes a process for the event.

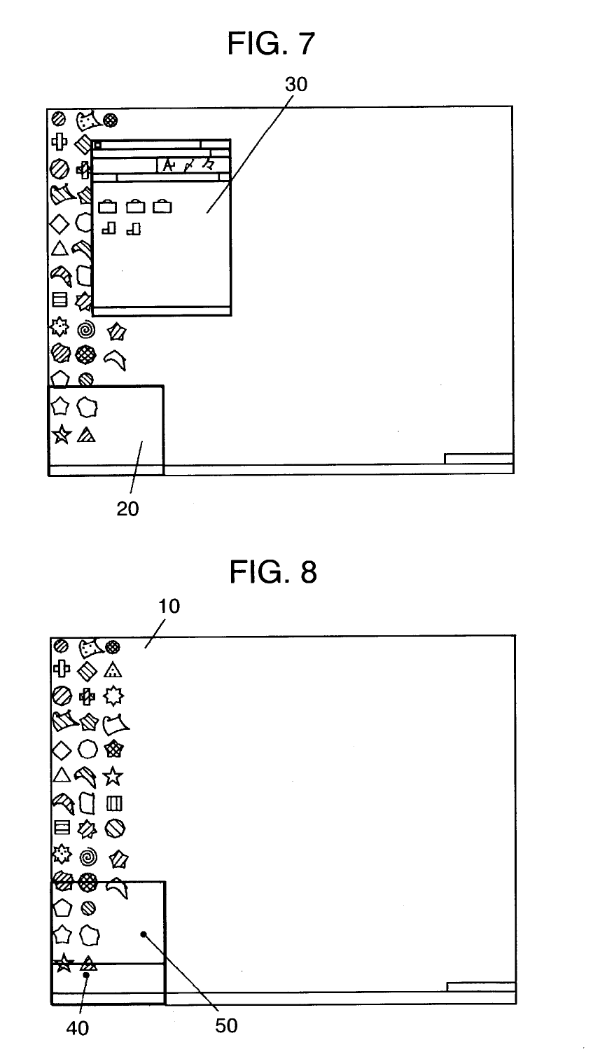

Server 2A issues the double click event of the mouse to coordinates (where an icon exists) specified by terminal 1 in the present embodiment. Control unit 2C executes a program for the icon with the OS. As a result, the folder is opened as shown in window 30 of FIG. 7.

After analyzing unit 2H finishes the analysis of the input information transmitted from terminal 1 and the issue of the event to control unit 2C, the display image information is obtained and processed and difference of the image is detected as shown in steps S2-2 to S2-5. When there is no difference between the second display image information transmitted last time and the display image information processed newly this time, the transmission (S2-6) of the display image information is skipped.

A case where the operation command from terminal 1 is a change request of a display position is described hereinafter.

The input information for the change request of the display position from the user is transmitted to server 2A in steps S1-7 and S1-8. Here, upward change of the display position is assumed to be requested, and input information (“change the display position upward”, no coordinate information) is thus transmitted to server 2A.

Server 2A receives the input information from terminal 1 and analyses it in steps S2-7 and S2-8, as discussed above. Differently from the analysis of the input information discussed above, the own processing event of terminal 1 is analyzed. Server 2A obtains, from storage unit 2J, image information to be displayed on terminal 1 for the event “change the display position upward”, and transmits the image information to terminal 1. The following operations are executed for this purpose.

In server 2A, in extracting display image information, obtaining unit 2E determines that the input information from the user is the command “change the display position upward”. Obtaining unit 2E extracts image information in a rectangular region of (0, 0+n) to (320, 240+n) based on the positional information presently displayed on LCD 3B of terminal 1. The positional information is coordinate information of the second display image information last time stored in storage unit 2F. Here, n is a value defined by a system and is not specified in the present embodiment.

FIG. 8 shows an image extracted from an image displayed on PC 2 at this time. FIG. 8 shows region 40 displayed on the control terminal before requesting for the change of the display position and extracted region 50 after requesting for the upward change of the display position.

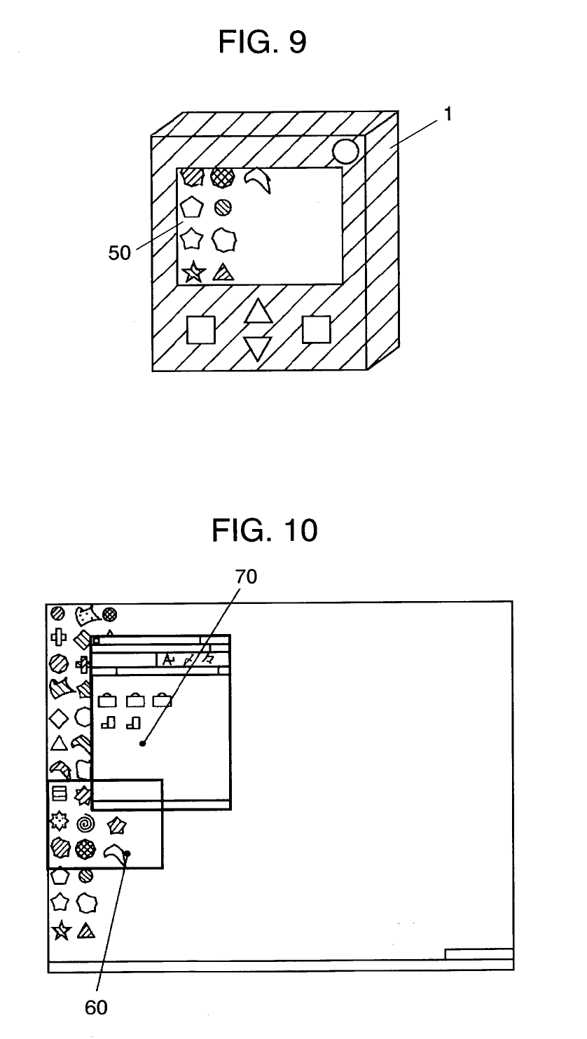

Detecting unit 2K then detects a difference between the extracted image and the image transmitted to terminal 1 last time. The change of the display position results in the difference, so that server 2A transmits the extracted image. Terminal 1 receives the second display image information transmitted from server 2A and displays it on display unit 1E, thereby changing the display position. FIG. 9 shows the resultant state of terminal 1.

As discussed above, in remotely controlling PC 2 from terminal 1, the system of the present embodiment changes and transmits the display image information of PC 2 in response to the size of LCD 3B of terminal 1. Thus, terminal 1 need not receive an image in a region that is not displayed for the present. Data amount transferred at a time is reduced, and delay of display and degradation of the operation response that occur in transferring data are suppressed. The communication is more efficient than the case of transmitting image information of the full screen of PC 2 to terminal 1.

When server 2A extracts display image information to be transmitted to terminal 1, the image on the foreground window is sometimes partially cut after the extraction. In this case, an image with the size of LCD 3B of terminal 1 is not extracted, but an image in a rectangular region including the window frame on the foreground is preferably extracted. Terminal 1 displays the extracted image.

FIG. 10 shows the situation. Region 60 is an extracted image region having the size of LCD 3B of terminal 1, and region 70 is a newly extracted region to be transmitted to terminal 1.

An image on the foreground window that has much chance of being operated by the user can thus previously transmitted, and transaction processing required for image transfer between server 2A and terminal 1 is reduced.

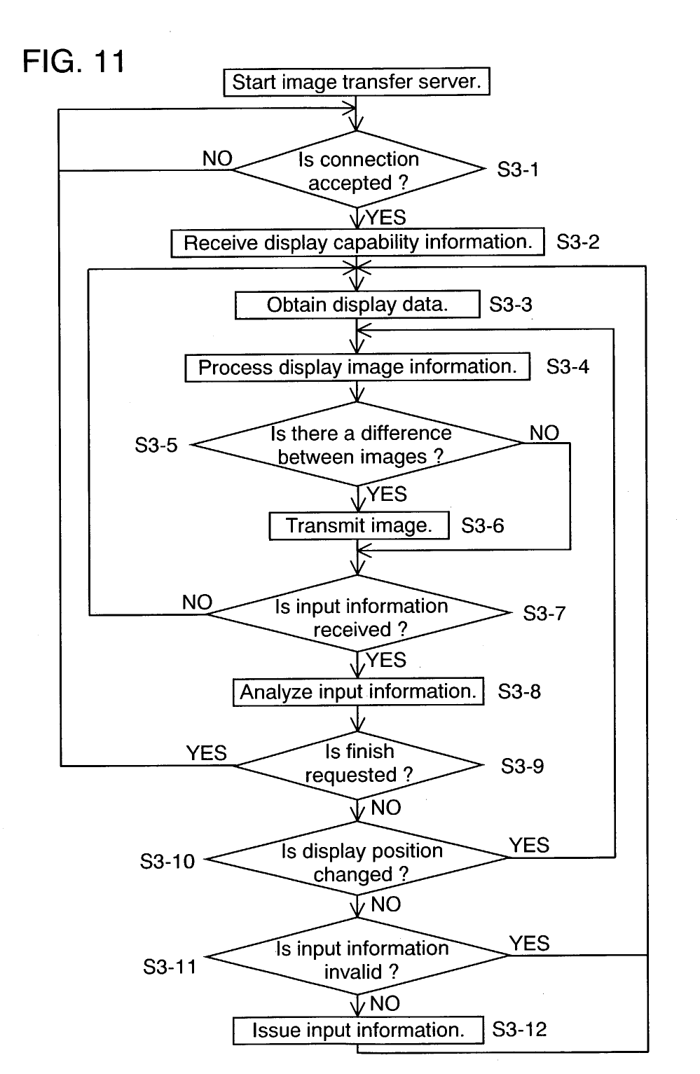

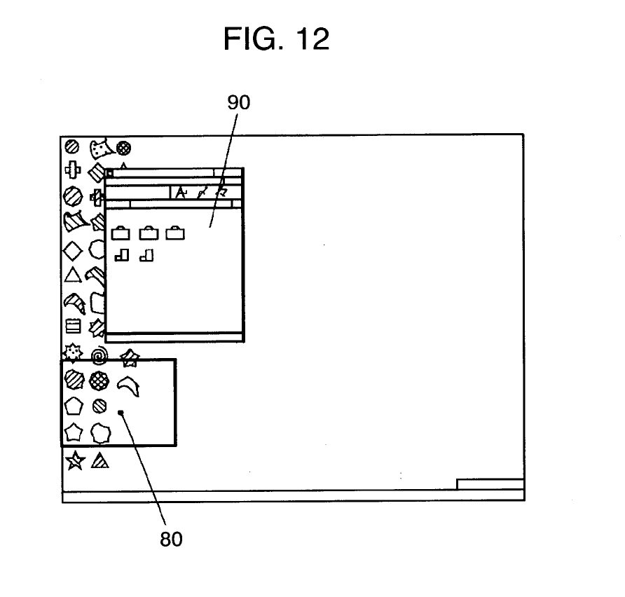

In the flowchart of FIG. 11, when server 2A determines that input information from input unit 1A of terminal 1 is event information for a foreground window in a region that is not displayed on terminal 1 in analyzing the input information, server 2A may invalidate the input information and skip issuing of the event. In other words, the event is determined to be invalid and a command for the foreground window is skipped. In FIG. 12, for example, display region 80 is displayed on terminal 1, and foreground window 90 is not displayed on LCD 3B of terminal 1. In this case, even when the input information “close the window” on LCD 3B is transmitted from terminal 1, control unit 2L determines that the event is invalid and executes no process (S3-11). The issue of the window event to non-display foreground window 90 is thus suppressed. Closing of a window existing in a region that is not seen from the user is suppressed from causing confusion of the user.

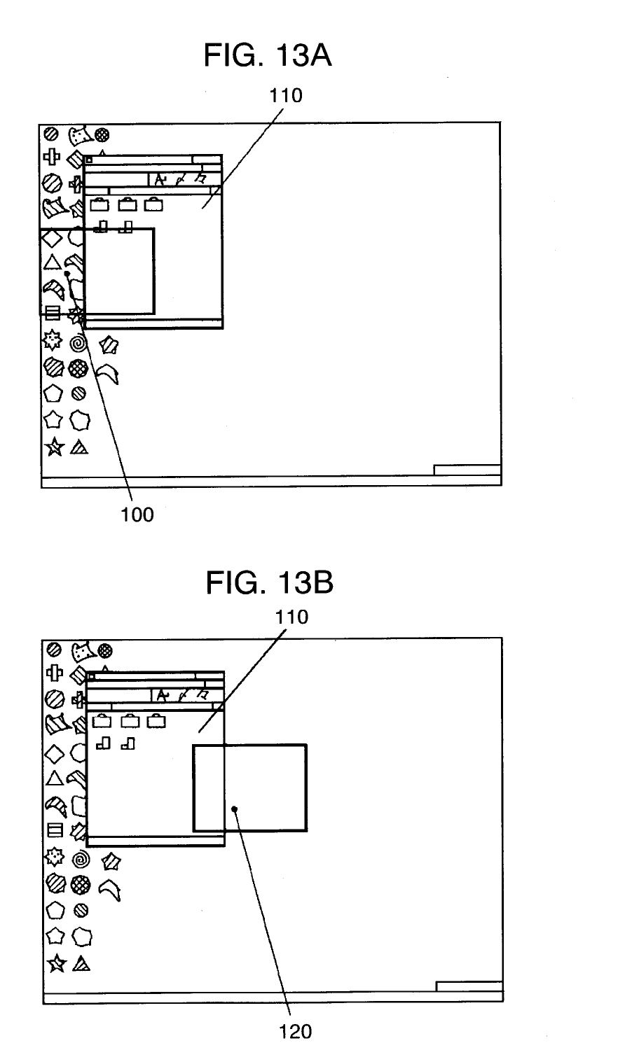

When input information is event information for a foreground window displayed on terminal 1 in analyzing the input information with server 2A, server 2A may determine whether or not to issue the event based on area information of the foreground window. When window 110 is overlapped on 50% or more of display region 100 of LCD 3B of terminal 1 as shown in FIG. 13A, for example, control unit 2L determines that the event is valid. When window 110 is overlapped on less than 50% of display region 120 as shown in FIG. 13B, for example, control unit 2L determines that the event is invalid. A threshold for determination of the display region is 50% in the present embodiment; however, the present invention is not limited to this threshold. The user may set an arbitrary value as a threshold, and the set information may be stored in storage unit 2F or storage unit 1C. This structure improves accuracy in invalidating a window event comparing the case in which an operation command from the user is invalidated simply by non-display of the window.

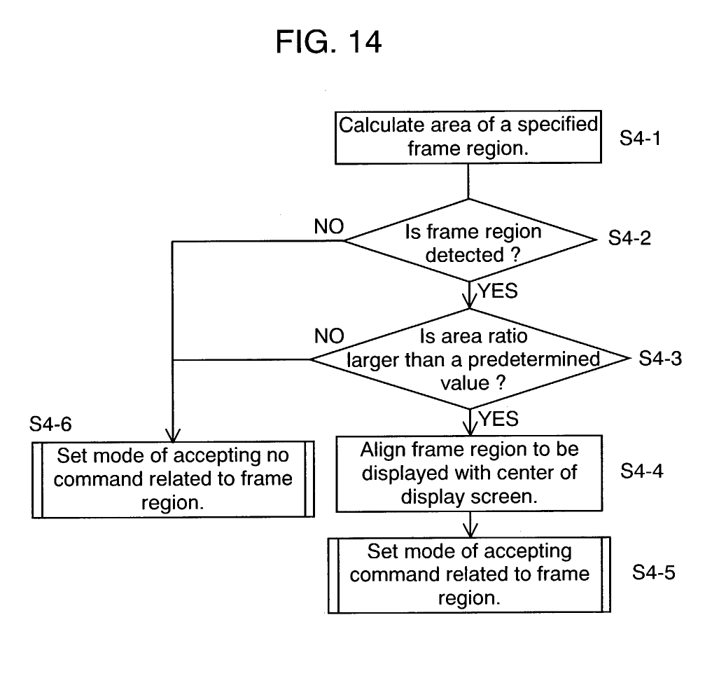

The screen display discussed above is hereinafter described in detail in accordance with the flowchart of FIG. 14. When region 100 of the screen of PC 2 is displayed on the screen of terminal 1 as shown in FIG. 13A, region calculating unit 2M calculates a ratio of the area of the window frame in window display. Region calculating unit 2M derives an area of a frame image to be displayed based on respective position coordinates of region 100 and the window region overlapped on region 100. Region calculating unit 2M calculates a ratio of window display area to the display screen area of terminal 1 (S4-1). Region calculating unit 2M detects whether or not the ratio of the area of the frame is zero in step S4-2.

Region calculating unit 2M determines whether or not the ratio of the calculated region is larger than a predetermined ratio in step S4-3. When region calculating unit 2M calculates the ratio of the calculated region, which is larger than the predetermined ratio, the process proceeds to step S4-4. Obtaining unit 2E aligns the coordinate position of the center of the display screen of terminal 1 with the center of the entire frame image. Not the image in presently selected region 100 but the frame image is displayed on the screen of terminal 1. In aligning the centers with each other based on the result of calculating unit 2M, obtaining unit 2E may select a window frame so that the display ratio is 100%, and may display the frame on the screen of terminal 1. In the latter case, both centers are not necessarily aligned with each other.

In step S4-5, control unit 2L sets control unit 2C to be in a mode of accepting a command related to the frame image from input unit 1A of terminal 1.

When calculating unit 2M does not detect the frame region at all in step S4-2 or does not calculate the frame screen having the predetermined ratio or more (FIG. 13B) in step S4-3, control unit 2L sets control unit 2C to be in a mode of skipping the accepting process of the command related to the frame image from input unit 1A of terminal 1 (S4-6). The user can arbitrarily change the occupying ratio on the display screen of terminal 1, and the ratio information is stored in terminal information storage unit 1C.

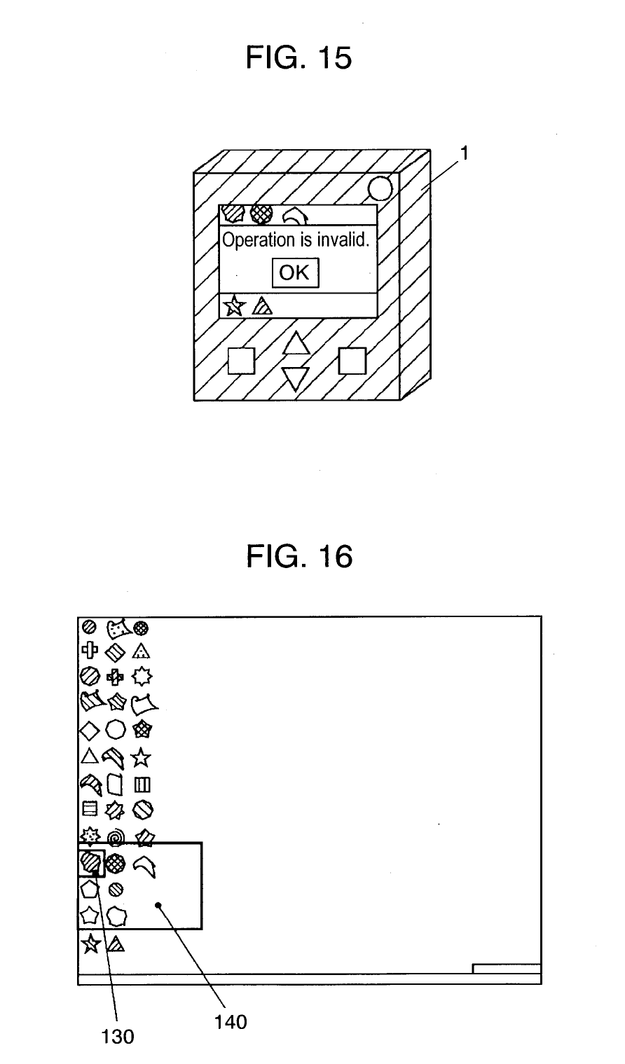

When server 2A or terminal 1 determines invalidity of the operation command, display unit 1E of terminal 1 may display the caution of the invalidity or informing unit 1G may announce the invalidity (make a beep). For example, display unit 1E displays “The command is invalid”. FIG. 15 shows the state of terminal 1 at this time. Even when PC 2 does not respond to a result by an operation of the user at terminal 1, the user can be suppressed from feeling anxiety.

Information on whether or not a foreground window exists may be added to the display image information to be transmitted from server 2A to terminal 1 in the present embodiment. When the foreground window exists, information of the area occupying LCD 3B may be added to the display image information for transmission. Terminal 1 can thus determine validity or invalidity of the operation command of the user and suppress communication in response to the operation command. This function reduces transaction in response to an operation request occurring when the operation instruction is invalid.

Server 2A obtains the display image information from display unit 2B and detects a difference. When the difference is detected, only display image information of the difference may be transmitted. For example, when an icon on the touch panel of terminal 1 is tapped and an icon on display unit 2B of PC 2 is highlighted in reverse, the display image information of a rectangular region surrounding the region having the difference detected in the difference detecting process and the region information are transmitted to terminal 1.

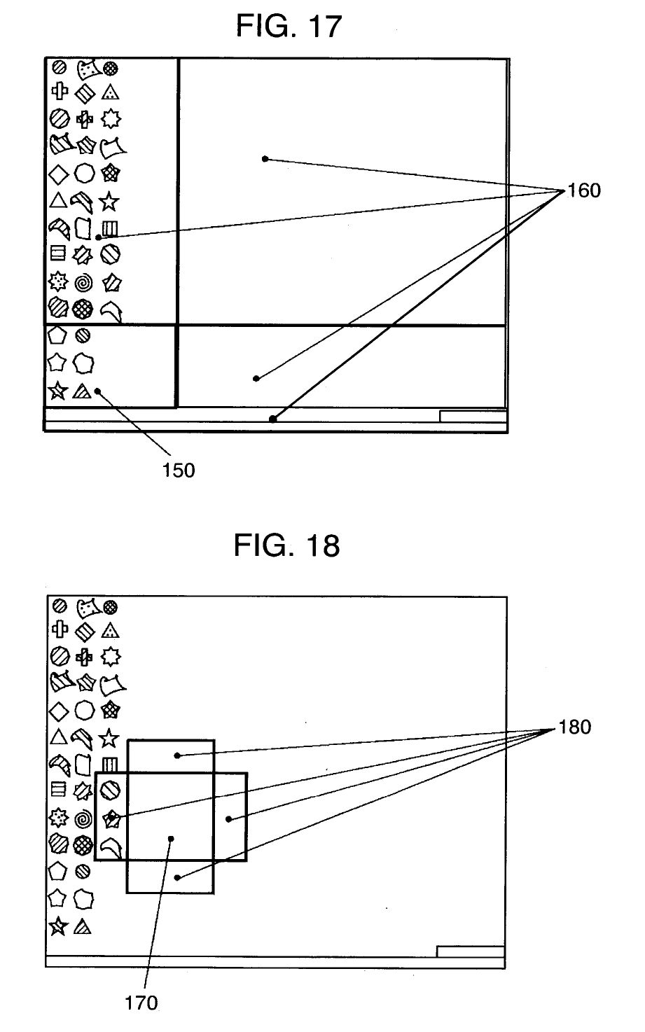

FIG. 16 shows the situation, region 130 indicates an update region, and region 140 indicates a region displayed on the LCD of the control terminal. Terminal 1 receives the display image information and the region information, and displays the updated image to the received region.

Server 2A thus transmits only the image of the update part of the screen to terminal 1. Communication traffic required for transmitting the display image information is therefore reduced. The image comparing process executed in the difference detecting process in server 2A is limited to the region displayed on terminal 1. The load on the difference detecting process is therefore reduced comparing with the case of transmitting the entire display image information on an controlled computer to terminal 1.

When input information is not received, server 2A repeatedly obtains the display image information from display unit 2B and detects an image difference in the present embodiment. When input information is not received for a certain period, server 2A may transmit data of a region that is not being displayed on LCD 3B of terminal 1.

For example, in FIG. 17, server 2A previously transmits non-display region 160 to terminal 1 when region 150 is displayed on terminal 1. In other words, a communication process required for transmitting and receiving display image information in executing a changing operation of the display region position on terminal 1 can be previously performed. Processing efficiency in the changing operation of the display region position is thus improved.

In the situation discussed above, the extraction from display image information is not performed but the display image information itself may be transmitted. In this case, the entire display image information is transmitted to terminal 1 in the certain period when input information is not received. The communication of the display image information is not required for the changing operation of the display region position, so that the response to the changing operation of the display region position is improved.

In the situation discussed above, server 2A may previously transmit, of the obtained display image information, only display image information of the region that is not displayed on LCD 3B of terminal 1 but transmitted in response to a request for changing the display position. For example, it is assumed in the present embodiment that the vertical and transverse change of the display position is allowed and region 170 is displayed on terminal 1 as shown in FIG. 18. Server 2A transmits non-display region 180 to terminal 1. Only the difference image of the display image information required for the changing operation of the display region position on terminal 1 is previously transmitted, so that the response to the changing operation of the display region position is improved.

Many modifications and variations of the present invention are possible in the light of the above techniques. It is therefore to be understood that within the scope of the invention the invention may be practiced otherwise than as specifically described.

What is claimed is:

1. A communication control system comprising a terminal having a display unit for displaying an image and a computer, and transmitting first image information stored in said computer to said terminal,
wherein said terminal transmits image display capability information of said terminal to said computer, said computer then changes the first image information to second image information based on the image display capability information and transmits the second image information to said terminal, and said terminal receives the second image information and displays the second image information on the display unit.

2. A communication control system according to claim 1, wherein
said computer comprises
a first storage unit for storing the first image information,
a changing unit for changing the first image information, and
a first communication unit for transmitting and receiving various information,
said terminal further comprises
a second storage unit for storing the second image information to be displayed on the display unit,
a third storage unit for storing image display capability information of the display unit, and
a second communication unit for transmitting and receiving various information to said computer, and
the second communication unit transmits image display capability information stored in the third storage unit to the first communication unit, the changing unit then changes the first image information in the first storage unit based on the image display capability information, the first communication unit transmits the second image information to the second communication unit, the second storage unit stores the second image information, and the display unit displays the second image information.

3. A communication control system according to claim 1,
wherein the image display capability information includes at least one of screen size of the display unit and resolution information of the screen of the display unit.

4. A communication control system according to claim 3,
wherein the computer extracts one of the screen size of the display unit and the resolution size of the screen of the display unit from the first image information.

5. A communication control system according to claim 3,
wherein the image display capability information further includes pixel information of the screen of the display unit.

6. A communication control system according to claim 2,
wherein after the image changed by the changing unit is updated said computer transmits information of the updated image information to said terminal.

7. A communication control system according to claim 2,
wherein after the image changed by the changing unit is updated said computer transmits image information of the updated part to said terminal.

8. A communication control system according to claim 2, wherein
said computer further comprises a region calculating unit for detecting a region of a frame image, the frame image being included in the second image information and is displayed on the display unit, and
the display unit of said terminal displays only the frame image, when the region calculating unit detects that part of the frame image is included in the second image information.

9. A communication control system according to claim 2, wherein
said computer further comprises a region calculating unit for detecting a region of a frame image, the frame image being included in the second image information and displayed on the display unit,
said terminal further comprises an input unit used for input of a various command by a user, and
the command related to the frame image fed from the input unit is skipped in one of the cases: A) when the second image information displayed on the display unit includes only information other than the frame image; and B) when the second image information displayed on the display unit includes only the frame image at an area ratio less than a predetermined value.

10. A communication control system according to claim 9, wherein
said terminal further comprises an informing unit operated when the command is skipped.

11. A communication control system according to claim 9, wherein
a user sets a predetermined area ratio of the frame image to be detected by the region calculating unit.

12. A communication control system according to claim 2, wherein
when the second image information includes a frame image, the second communication unit further transmits, to the first communication unit, information indicating that the second image information includes the frame image.

13. A communication control system according to claim 4, wherein
when the image changed by the changing unit is the same before and after a lapse of a predetermined time, the first communication unit transmits at least third image information other than the extracted image to the second communication unit.

14. A communication control system according to claim 13, wherein
said terminal further comprises an input unit used by a user for inputting a request for changing a display position of the display unit, and
the third image information other than the extracted image is image information in a region responding to the request for changing the display position.

15. A storage medium for storing an image transfer program of a communication control system, the system comprising a terminal having a display unit for displaying an image and a computer storing first image information, the image transfer program including the steps of:
A) transmitting image display capability information of the terminal from the terminal to the computer;
B) changing the first image information to second image information based on the image display capability information;
C) transmitting the second image information from the computer to the terminal; and
D) displaying the second image information on the display unit.

16. A storage medium according to claim 15, wherein
the computer comprises
a first storage unit for storing the first image information,
a changing unit for changing the first image information, and
a first communication unit for transmitting and receiving various information,
the terminal further comprises
a second storage unit for storing the second image information to be displayed on the display unit,
a third storage unit for storing image display capability information of the display unit, and
a second communication unit for transmitting and receiving various information to said computer,
step A includes a step of
E) transmitting the image display capability information stored in the third storage unit from the second communication unit to the first communication unit
step B includes a step of
F) changing the first image information in the first storage unit based on the image display capability information,
step C includes a step of
G) transmitting the second image information from the first communication unit to the second communication unit, and
step D includes steps of
H) storing the second image information in the second storage unit, and
J) displaying the second image information on the display unit.

17. A storage medium according to claim 15,
wherein the image display capability information includes at least one of screen size of the display unit and resolution information of the screen of the display unit.
